(19) United States
(12) Patent Application Publication
(10) Pub. No.: US 2002/0145294 A1
(43) Pub. Date: Oct. 10, 2002

(54) Hand tool for lifting and carrying objects

(76) Inventors: Jay S. Clark, Onalaska, WI (US); Weston J. Thorne, Muncie, IN (US)

Correspondence Address: TAYLOR & AUST, P.C., 142 S. Main St., P.O. Box 560, Avilla, IN, 46710, US

(21) Appl. No.: 10/117,398

(22) Filed: Apr. 5, 2002

Related U.S. Application Data
(60) Provisional application No. 60/282,418, filed on Apr. 9, 2001.

(51) Int. Cl. B65G 7/12

(52) U.S. Cl. 294/15; 294/92

(57) ABSTRACT

A carry tool including a frame being V-shaped at an obtuse angle having a first end, a second end and a vertex portion and three fingers including a first finger, a second finger and a third finger, each finger having a first end connected to the same side of said frame, the first finger connected proximate the first end of the frame, the second finger connected to the frame proximate to the vertex portion, the third finger connected to the frame proximate the second end, each finger substantially parallel to another finger.

### CROSS REFERENCE TO RELATED APPLICATIONS

This application claims the benefit of U.S. Provisional Application No. 60/282,418, filed Apr. 9, 2001.

### 1. FIELD OF THE INVENTION

The present invention relates to a hand tool for lifting and carrying objects, and, more particularly, to a hand tool for lifting and carrying planar material.

### 2. DESCRIPTION OF THE RELATED ART

Lifting devices may be categorized as those that increase the lifting power of an individual and those that facilitate the lifting of an object. Those lifting devices that multiply lifting force include a jack, a winch, a windlass and a hoist. A jack has a mechanical advantage supplied by either a screw or a hydraulic pressure system. A winch is a mechanical device for hauling or lifting which includes a movable drum around which a cable is wound such that rotation of the drum produces a drawing force at the end of a cable. A windlass is essentially the same device as a winch, except that a winch may be power driven whereas a windlass is usually hand powered and somewhat less sophisticated. A hoist is another closely related device, mounted so as to be movable, as in a traveling crane.

Devices to facilitate lifting include such things as slings and handles, which are affixed to the item to be carried. Slings are employed to facilitate the lifting and carrying of such things as a rifle or a backpack, which are used by military personnel to carry military and survival equipment. Handles are affixed to such things as consumer products, tools and suitcases, to facilitate the lifting and carrying of the respective item.

The lifting of an item without handles is usually accomplished by placing a lifting device under an item and lifting the item up with the lifting device. If the material to be lifted is ferrous a magnetic lifting device may be employed. The lifting of sheets of building material is done in bulk with forklifts and the movement of single sheets is a job that normally requires the attention of two people. Whereas sheets of building material have no attached handle, the lifting of sheets of material by hand is a cumbersome error prone procedure.

What is needed in the art is a relatively easy way to lift planar material.

### SUMMARY OF THE INVENTION

The present invention provides a hand tool for lifting and carrying objects that accomplishes the lifting of planar material in an easy manner.

The invention comprises, in one form thereof, a carry tool including a frame being V-shaped at an obtuse angle having a first end, a second end and a vertex portion and three fingers including a first finger, a second finger and a third finger, each finger having a first end connected to the same side of said frame, the first finger connected proximate the first end of the frame, the second finger connected to the frame proximate to the vertex portion, the third finger connected to the frame proximate the second end, each finger substantially parallel to another finger.

An advantage of the present invention is that the lifting tool allows easy lifting of planar materials such as drywall and plywood.

Another advantage is that the lifting tool does not require permanent installation to the planar material, which is carried.

Yet another advantage is that the lifting tool can be applied to either end of the planar material.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of some planar material engaged by an embodiment of a lifting device of the present invention;

FIG. 2 is another perspective view of the lifting device of FIG. 1;

FIG. 3 is a front view of the lifting device shown in FIG. 1 and 2; and

FIG. 4 is a partially exploded view of another embodiment of the lifting device of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

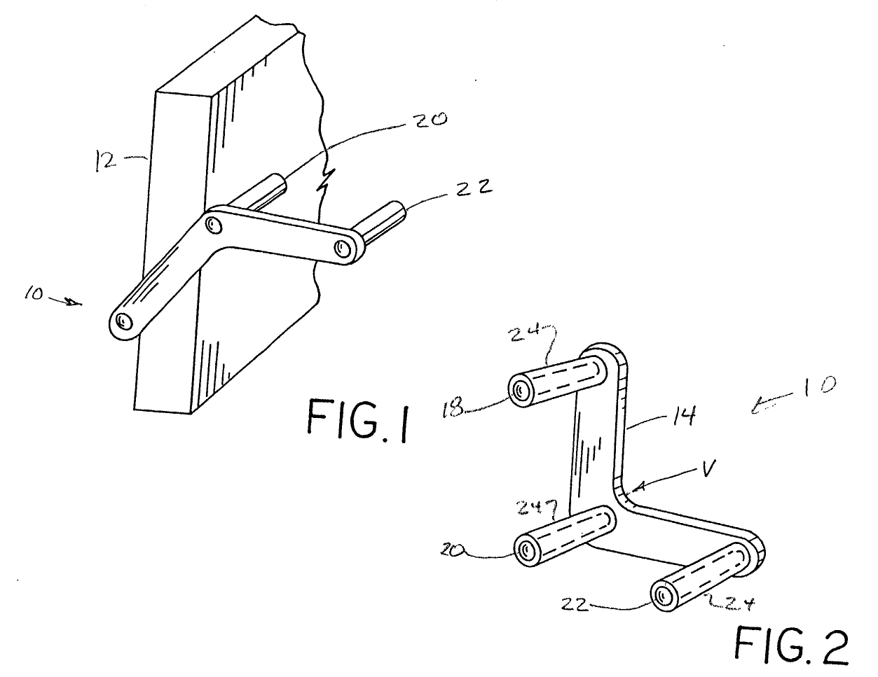

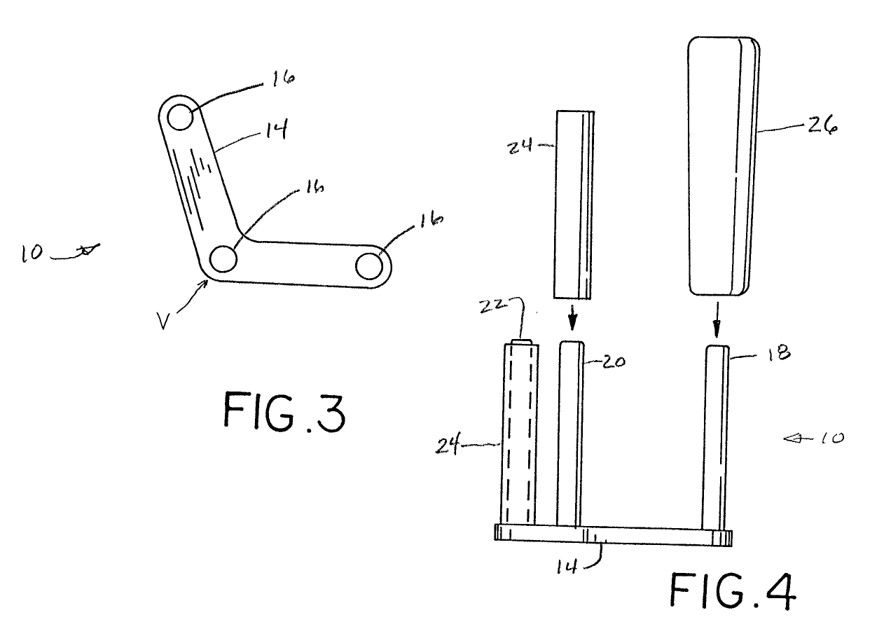

Referring now to the drawings, and more particularly to FIGS. 1-3, there is shown an embodiment of the present invention including lifting device 10, shown engaging planar material 12 in FIG. 1. Planar material 12 includes any type of material that is in a sheet form, such as drywall, plywood and doors. Lifting device 10 includes frame 14 with holes 16 and fingers 18, 20 and 22.

Frame 14 is generally V-shaped at an obtuse angle, being made from a generally flat material and having holes 16 disposed proximate each end and at vertex V. Holes 16 are made to accommodate fingers 18, 20 and 22, which are inserted, thereinto and welded to frame 14. While the angle of frame 14 can be from 90° to 180°, in a preferred embodiment the angle will be between 105° and 145°. Frame 14 is made from a resilient material such as steel, aluminum, titanium, carbon fibers or some forms of plastic.

Fingers 18, 20 and 22 are cylindrical bars which are inserted into holes 16 of frame 14 are welded thereto. Fingers 18, 20 and 22 are generally parallel with each other and generally normal with a surface of frame 14. Compressible sleeves 24 are removably engaged with the cylindrical surface of fingers 18, 20 and 22. Compressible sleeves 24 are placed over fingers 18, 20 and 22 to provide a greater coefficient of friction between lifting device 10 and planar material 12, which assists in the lifting of planar material 12. Compressible sleeves 24 may extend over the full length of fingers 18, 20 and 22 or at least partially over the cylindrical surface of fingers 18, 20 and 22. Although compressible sleeves 24 are shown as a cylindrical hose-like material, compressible sleeves 24 can be made with flat surfaces or curved surfaces along the length there of to accommodate different types of material. Alternatively, fingers 18, 20 and/or 22 may be shaped with edges and/or curves to accommodate the lifting and carrying of materials other than planar materials.

Now additionally referring to FIG. 4, there is shown another embodiment of lifting device 10 of the present invention including frame 14, fingers 18, 20, 22, two compressible sleeves 24 and handle sleeve 26. This embodiment is substantially similar to the previous embodiment with an addition of handle sleeve 26, which is larger than compressible sleeve 24 and shaped to accommodate a hand of an individual. Handle sleeve 26 is inserted over finger 18 in lieu of one of compressible sleeves 24. Handle sleeve 26 may be removed from finger 18 and placed on finger 22 to accommodate lifting at an opposite end of planar material 12. Alternatively, handle sleeve 26 may be sized to slide over a compressible sleeve 24 allowing handle sleeve 26 to be easily placed at either end of lifting device 10.

Lifting device 10 is used to lift planar material 12 by orienting lifting device 10 such that vertex V of frame 14 is positioned in a generally upward manner. Lifting device 10 is then positioned such that one finger, such as finger 18, is placed on one side of planar material 12 and finger 20 is placed on another side of planar material 12, as illustrated in FIG. 1. Lifting of planar material 12 is then accomplished by lifting on finger 22. The friction of compressible sleeves 24, as they engage planar material 12, along with the camming type action of the lift force, as it is applied to finger 18, allows lifting device 10 to securely grasp planar material 12 thereby allowing an individual to lift planar material 12 using one of fingers 18 or 22 as a handle. A like engagement of another lifting device 10 at an opposite end of planar material 12 allows two individuals to easily carry one or more pieces of planar material 12 that are engaged between fingers 18 and 20.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A carry tool, comprising:
a frame being V-shaped at an obtuse angle having a first end, a second end and a vertex portion; and
three fingers including a first finger, a second finger and a third finger, each finger having a first end connected to the same side of said frame, said first finger connected proximate said first end of said frame, said second finger connected to said frame proximate said vertex portion, said third finger connected to said frame proximate said second end.

2. The device of claim 1, wherein each said finger is substantially parallel to another said finger.

3. The device of claim 1, wherein said obtuse angle is greater than 105° and less than 145°.

4. The device of claim 1, further comprising a plurality of compressible sleeves, each compressible sleeve encompassing at least a portion of a corresponding one of said plurality of fingers.

5. The device of claim 1, further comprising:
a plurality of compressible sleeves, each compressible sleeve encompassing at least a portion of a corresponding one of said plurality of fingers; and
a handle encompassing at least a portion of a corresponding one of said plurality of fingers.

6. A sheet material lifting device, comprising:
a frame; and
a plurality of fingers, each of said plurality of fingers including a first end connected to said frame, at least two of said plurality of fingers substantially parallel to each other.

7. The device of claim 6, wherein said plurality of fingers include a first finger, a second finger and a third finger, said first, second and third fingers substantially parallel with each other.

8. The device of claim 6, wherein said frame is V-shaped at an obtuse angle.

9. The device of claim 8, wherein said obtuse angle is greater than 105° and less than 145°.

10. The device of claim 8, wherein said frame includes a first end, a second end and a vertex portion, said plurality of fingers including a first finger, a second finger and a third finger, said first end of each said finger being connected to the same side of said frame, said first finger connected proximate said first end of said frame, said second finger connected to said frame proximate said vertex portion, said third finger connected to said frame proximate said second end.

11. The device of claim 6, further comprising a plurality of compressible sleeves, each compressible sleeve encompassing at least a portion of a corresponding one of said plurality of fingers.

12. The device of claim 6, further comprising:
a plurality of compressible sleeves, each compressible sleeve encompassing at least a portion of a corresponding one of said plurality of fingers; and
a handle encompassing at least a portion of a corresponding one of said plurality of fingers.

13. A method of lifting a sheet of material, comprising the steps of:
providing a carry tool having an obtuse angled V-shaped frame, said frame having three fingers attached thereto at a first end, a second end and a vertex portion of said frame;
positioning one finger of said carry tool on one side of an end of said sheet and an other finger of said carry tool on an other side of said sheet; and
lifting on a third finger of said carry tool.

14. The method of claim 13, further comprising the step of orienting said carry tool such that a vertex portion of said carry tool is oriented generally upward.

15. The method of claim 13, further comprising the step of positioning another carry tool on an opposite end of said sheet.
